(19) United States
(12) Patent Application Publication
(10) Pub. No.: US 2012/0193951 A1
(43) Pub. Date: Aug. 2, 2012

(54) Fisherman's chair support assembly

(76) Inventor: Seth Solomon, Glenmore, LA (US)

(21) Appl. No.: 12/931,339

(22) Filed: Jan. 31, 2011

(51) Int. Cl. B60N 2/44; A01K 97/10

(52) U.S. Cl. 297/188.01

(57) ABSTRACT

A support for a fisherman's chair has a frame for supporting a plurality of fishing rods and an upright pedestal extending through the frame. A fisherman's chair can be detachably secured to the pedestal. The pedestal's lower end is received in a mounting plate that is attached to a bar extending substantially transversely to the pedestal. The bar is securable to a hitch of a towing vehicle. The fisherman's chair is supported by the towing vehicle in a cantilevered fashion, allowing the chair's footrest to be positioned above ground.

### BACKGROUND OF THE INVENTION

The present invention relates generally to a rod holder, and more particularly to a fisherman's chair and a support assembly for holding fishing rods and allowing a fisherman to sit in a chair during fishing.

Many people enjoy recreational fishing. Most everyone has at one time or another fished from the shore, a bank of a lake, pond, or river. Many people who fish stay at one location for a considerable period of time and they prefer to sit down while fishing. While some people enjoy sitting on the river bank others prefer sitting in a chair. A fisherman can sit in the chair holding a fishing rod or position the rod in a separate holder. Some portable fishing chairs include pouches, straps, or other accessories that help position the fishing rod in close proximity to the fisherman.

When placing a conventional fishing chair having front and rear legs on a sandy or soggy river bank, the person sitting often feels off balance or feels a considerable strain since the chair legs penetrate the soil at different levels. Additionally, a sloping bank presents challenges for positioning of a conventional chair. An uneven chair is uncomfortable for the fisherman. In this respect, it would be desirable if a chair for fishermen were provided that permitted a fisherman to sit comfortably on the chair regardless of the conditions of the soil in the particular location.

Some fishing chairs have adjustable legs that permit the seat of the chair to be adjusted to a level orientation by shortening some legs to accommodate a sloped surface. Although such solution addresses the problem of a sloped bank of a body of water, this chair does not address another important problem of a fisherman sitting on a bank—that of soft or sandy soil. Often the sand or soil is not packed tightly. For this reason, the legs of the chair may readily wander as the person sits on the chair. Thus, while conventional chair can be useful under certain conditions they still lack many desirable qualities.

Some locations allow a fisherman to drive almost to the water edge in which case the chair is positioned next to a car or truck. The present invention contemplates provision of a fishing rod holder associated with a fisherman's chair that can be supported by a hitch of a truck or other such towing vehicle equipped with a hitch receiver. Other advantages of the present invention over the prior art also will be evident.

### SUMMARY OF THE INVENTION

It is, therefore, an object of the present invention to provide a support for a fisherman's chair configured to hold one or more fishing rods.

It is another object of the invention to provide a support for a fisherman's chair that can be detachably engaged with a trailer hitch of a towing vehicle.

It is a further object of the invention to provide a support assembly for a fisherman's chair that is configured for pivotal movement around a pedestal.

These and other objects of the invention are achieved through a provision of a support for a fisherman's chair has a frame for supporting a plurality of fishing rods and an upright pedestal extending through the frame. A fisherman's chair can be detachably secured to the pedestal. The pedestal's lower end is received in a mounting plate that is attached to a bar extending substantially transversely to the pedestal. The bar is securable to a hitch of a towing vehicle. The fisherman's chair is supported by the towing vehicle in a cantilevered fashion, allowing the chair's footrest to be positioned above ground. The frame assembly is reinforced with angular braces, which are positioned in a load-sharing relationship.

### BRIEF DESCRIPTION OF THE DRAWINGS

Reference will now be made to the drawings, wherein like parts are designated by like numerals, and wherein

FIG. 1 is a perspective view of the support assembly for a fisherman's chair according to the present invention.

FIG. 2 is a plan view of a lower portion of the chair support assembly, with the chair and rod holder assembly removed for clarity.

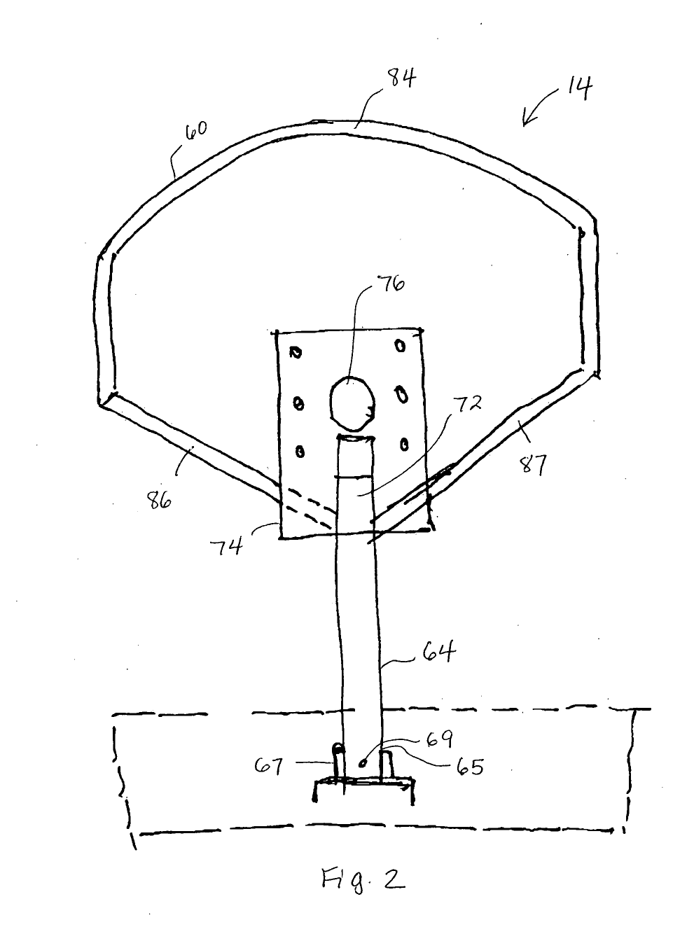

FIG. 3 is a perspective view of the support assembly fisherman's chair of the present invention illustrating the fisherman's chair in use.

### DETAIL DESCRIPTION OF THE INVENTION

Turning now to the drawings in more detail, numeral 10 designates the fisherman's chair and support apparatus according to the present invention. The apparatus 10 comprises a holder frame unit 12, a base assembly 14 and an optional chair assembly 16 detachably engageable with the frame 12 and the base assembly 14. The holder frame 12 has a generally triangular longitudinal section resembling an inverted triangle with a truncated apex.

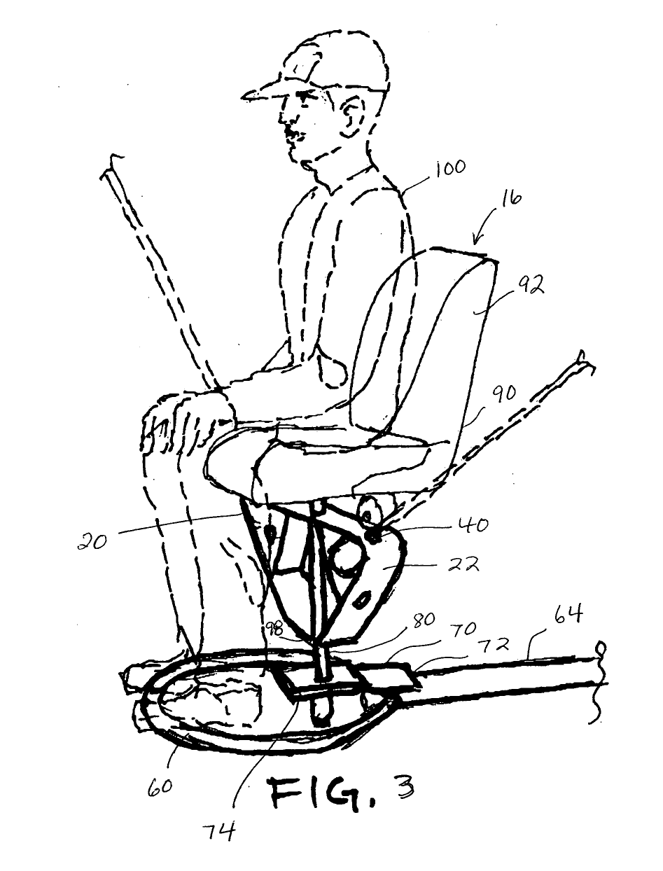

The holder frame unit 12 comprises an upper plate 16, a lower plate 18 a first side plate 20 and a second side plate 22 unitary connected together. The plates 16, 18, 20, and 22 have a generally planar aspect, as can be seen in FIG. 3. The lower plate 18 is oriented in a parallel relationship to the upper plate 16. The first side plate 20 and the second side plate 22 are secured at a generally acute angle in relation to the upper plate 16, and an obtuse angle—in relation to the lower plate 18.

A plurality of reinforcing braces extends between the side plates 20, 22 and the upper plate 16. The braces are spaced from each other in a load-sharing relationship. The first brace 30 is secured to extend between the upper plate 16 and the first side plate 20. The first brace 30 is attached at a substantially right angle to an underside of the upper plate 16. The second brace 32 is positioned closer to the geometric center of the upper plate 16; the second brace 32 is secured at a substantially right angle to the first side plate 20. A lower end of the second brace is fixedly attached to the first side plate 20.

The third brace 34 has an upper end secured to the underside 17 of the upper plate 16 in an equidistant location from the geometric center of the upper plate 16 as the second brace 32. The third brace 34 is secured at its lower end, to the second side plate 22 at a substantially right angle. The fourth brace 36 is secured in a mirror-image position to the first brace 30. The third brace extends at a substantially right angle to the upper plate 16.

The upper plate 16 is provided with a pair of apertures 40 (only one aperture 40 adjacent a corner 38 is shown in FIG. 3). It will be understood that a similar aperture is formed in the opposite end of the upper plate 16 adjacent a corner 39. A first rod holder 42 is secured to the first brace 30 in general alignment with the aperture 40. A second rod holder 46 is secured to the fourth brace 36 in general alignment with the other aperture 40. Each of the rod holders 42 and 46 can be formed as a hollow tubular body, which is configured to retain at least a part of a fishing rod handle 48 therein. The apertures 40 are configured to allow the handles 48 of the fishing rods to pass through the upper plate 16, while preventing the reels 50 of the fishing rods to pass therethrough.

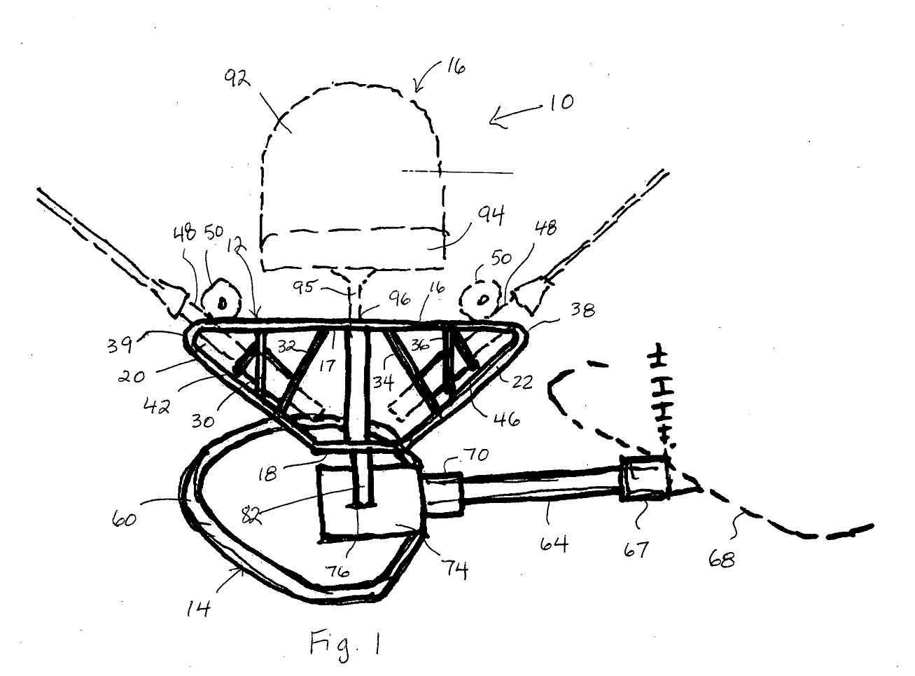

When the fishing rods are positioned in the holders 42 and 46, the fishing rods extend in a generally parallel relationship to the first side plate and the second side plate, as shown in FIG. 1. The fishing rod positioned in the holders 42 and 46 extend at an acute angle in relation to the pedestal, as will be described below, away from the chair 16 and do not interfere with the comfort of a fisherman 100.

The base assembly 14 comprises a base support 60 and a means for detachably securing the frame assembly to a hitch receiver of a towing vehicle. The mounting means comprises an elongated bar 64 fixedly attached to the base support 60. A proximate end 65 of the bar 64 is configured for fitting into the hitch receiver 67 of a towing vehicle 68. Such hitch receivers are usually pre-mounted on trucks, vans, SUV's and other vehicles. A pin 69 locks the bar 64 with the hitch receiver 67.

An attachment plate 70 is affixed to a distant end 72 of the elongated bar 64. A mounting plate 74 is secured to the attachment plate 70, extending at least in part over the base support 60. The mounting plate 74 is provided with an opening 76, which is configured to receive a lower end 80 of a pedestal 82. When the frame assembly 12 is engaged with the pedestal 82 the upper plate 16 and the lower plate 18 are oriented transversely to a longitudinal vertical axis of the pedestal 82. The cantilevered bar 64 is oriented transversely to the pedestal 82.

The base support 60 can be formed in any desired shape. In the embodiment shown in the drawings, the base support 60 has a rounded front portion 84 and a pair of rear portions 86 and 87. The rear portions 86 and 87 converge and are attached to the bar 64. The base support 60 serves as a foot rest for the fisherman 100 when the fisherman is seated in the chair.

The chair assembly 16 comprises a chair 90, which has a seat 94 and can be optionally provided with a back 92. The pedestal 82 is designed to receive a mounting pin 95 of the chair 90 and to lock the mounting pin therein. In such design the chair 90 is configured for rotation with the pedestal 82 in relation to the frame unit 12. A central opening 96 is formed in the upper plate 16, the opening 96 being vertically aligned with an opening 98 formed in the lower plate 18 of the frame assembly 12. The openings 96 and 98 are vertically aligned with the opening 76 formed in the mounting plate 74.

The pedestal 82 is engaged for a free rotation about 360-degrees curve within the frame assembly 12 and the base assembly 14. When the fisherman 100 is seated in the chair 90 the fisherman can orient the chair in any desired direction in relation to the bar 64. The chair assembly 16 is designed to be mounted to the open upper portion of the pedestal 82. The chair assembly 16 may be installed on the pedestal 82 either before or after the pedestal 82 is secured with the mounting plate 74.

Alternatively, the chair can be configured for rotational movement about a vertical axis defined by the pedestal 82 without the frame assembly 12. In such design, the mounting pin 95 is lowered into the open top of the pedestal 82 but not locked. In such design, the fisherman seated in the chair 90 can swivel the chair 360 degrees, while the frame assembly 12 with the rods remains oriented in the original position selected by the fisherman.

With multiple fishing rod holders 42, 46 mounted in the frame assembly 12, the fishing enthusiast can bait and cast two fishing rods. Once the fishing rods are secured in the fishing rod holders 42, 46 they simply need to be monitored for fish strikes. The chances of catching a fish are obviously enhanced with the multiple fishing rods. The rod holders 42, 46 are positioned on opposite sides of the frame assembly 12. The horizontal dimensions of the frame assembly 12 are selected to be at least slightly greater than the horizontal dimensions of the chair assembly 16 so that the fishing rods are positioned outside of the seat 94 while the fisherman 100 is seated in the chair 90.

The support apparatus of the present invention allows the fisherman to keep his feet dry since the foot rest 60 is cantilevered from the elongated bar 64, which is elevated above ground being engaged in the hitch 67 of the towing vehicle 68. In this position, the fisherman can continue fishing activity for longer period of time without being concerned about the footwear condition.

If desired, the pedestal 82 can be made height-adjustable using telescoping members to accommodate various height fishermen and position the footrest at the right distance from the seat of the chair.

It is envisioned that the chair 90 may be constructed with only a seat without the chair back if lighter construction is desired. The chair assembly, the base assembly and the frame assembly are preferably formed from a lightweight, non-corrosive material. The chair assembly may have a vinyl-covered seat and back, while the frame assembly and the support assembly can be formed from aluminum, rigid plastic and other suitable materials. The frame assembly allows the weight of the fisherman to be shared by the plates and the braces, thus facilitating long service of the apparatus.

The chair assembly, the frame assembly and the base assembly can be easily assembled and disassembled for storage and transportation. Moreover, it is envisioned that other existing chairs can be modified to engage with the frame assembly and the pedestal. It is further envisioned that a kit containing the pedestal with the frame assembly and the support assembly can be sold separately from the chair.

Many changes and modifications can be made in the design of the present invention without departing from the spirit thereof. I, therefore, pray that my rights to the present invention be limited only by the scope of the appended claims.

I claim:

1. A support apparatus for a fishing chair, comprising:
a frame assembly comprising fishing rod holders;
an upright pedestal extending vertically through the frame assembly;
a means for securing the pedestal to a hitch receiver of a towing vehicle configured to support the frame assembly in a cantilevered position above ground.

2. The apparatus of claim 1, further comprising a chair assembly supported on the pedestal above the frame assembly.

3. The apparatus of claim 2, wherein the chair assembly comprises a chair seat and a chair back secured to the chair seat.

4. The apparatus of claim 2, wherein said rod holders are mounted on the frame to support the fishing rods in a position oriented away from the chair assembly.

5. The apparatus of claim 2, wherein the chair assembly is rotationally engaged with the pedestal.

6. The apparatus of claim 2, wherein the chair assembly is fixedly secured to the pedestal and the pedestal is rotationally engaged with the means for securing the pedestal to the hitch receiver of a towing vehicle.

7. The apparatus of claim 1, wherein said frame assembly comprises an upper plate configured to extend transversely to a vertical axis of the pedestal, a lower plate extending in a generally parallel relationship to the upper frame, a first side plate and a second side plate connecting the upper plate to the lower plate.

8. The apparatus of claim 7, wherein said upper plate and said lower plate is each provided with a central opening for receiving the pedestal therethrough.

9. The apparatus of claim 7, wherein said upper plate is provided with a plurality of apertures each aperture being configured to receive a fishing rod therethrough.

10. The apparatus of claim 9, wherein each of said apertures is aligned with a fishing rod holder positioned within the frame assembly.

11. The apparatus of claim 7, wherein said frame assembly further comprises a plurality of angular braces extending between the upper plate and the side plates.

12. The apparatus of claim 11, wherein said plurality of angular braces comprises a first brace having an upper end attached at a right angle to the upper plate and a lower end secured to the first side plate, a second brace having a lower end secured at a right angle to the first side plate and an upper end secured to the upper plate, a third brace having a lower end secured at a right angle to the second side plate and an upper end secured to the upper plate, and a fourth brace having an upper end attached at a right angle to the upper plate and a lower end secured to the second side plate.

13. The apparatus of claim 1, wherein the means for securing the pedestal to a hitch of a towing vehicle comprises an elongated bar having a proximate end configured for locking engagement with the hitch of a towing vehicle and a mounting plate secured to the elongated bar, said mounting plate engaging a lower end of the pedestal.

14. The apparatus of claim 13, wherein the means for securing the pedestal to a hitch of a towing vehicle further comprises an attachment plate secured between the mounting plate and the elongated bar.

15. The apparatus of claim 1, further comprising a footrest attached to the means for securing the pedestal to a hitch of a towing vehicle, said footrest being mounted to extend above ground and below the frame assembly.

16. A support apparatus for a fishing chair, comprising:
a frame assembly comprising fishing rod holders;
an upright pedestal extending vertically through the frame assembly;
a chair assembly supported by the pedestal above the frame assembly, said chair assembly comprising a seat and a footrest;
a means for securing the pedestal to a hitch receiver of a towing vehicle configured to support the chair assembly in a cantilevered position above ground.

17. The apparatus of claim 16, wherein the chair assembly further comprises a chair back secured to the chair seat.

18. The apparatus of claim 16, wherein said rod holders are mounted on the frame to support the fishing rods in a position oriented away from the chair assembly.

19. The apparatus of claim 16, wherein the chair assembly is rotationally engaged with the pedestal.

20. The apparatus of claim 16, wherein the chair assembly is fixedly secured to the pedestal and the pedestal is rotationally engaged with the means for securing the pedestal to the hitch receiver of a towing vehicle.

21. The apparatus of claim 16, wherein said frame assembly comprises an upper plate configured to extend transversely to a vertical axis of the pedestal, a lower plate extending in a generally parallel relationship to the upper frame, a first side plate extending between the upper plate and the lower plate, a second side plate extending between the upper late and the lower plate and a plurality of angular braces secured between the upper plate and the fist side plate and the second side plate.

22. The apparatus of claim 21, wherein said upper plate and said lower plate is each provided with a central opening for receiving the pedestal therethrough.

23. The apparatus of claim 21, wherein said upper plate is provided with a plurality of apertures each aperture being configured to receive a fishing rod therethrough.

24. The apparatus of claim 23, wherein each of said apertures is aligned with a fishing rod holder positioned within the frame assembly.

25. The apparatus of claim 23, wherein said plurality of angular braces comprises a first brace having an upper end attached at a right angle to the upper plate and a lower end secured to the first side plate, a second brace having a lower end secured at a right angle to the first side plate and an upper end secured to the upper plate, a third brace having a lower end secured at a right angle to the second side plate and an upper end secured to the upper plate, and a fourth brace having an upper end attached at a right angle to the upper plate and a lower end secured to the second side plate.

26. The apparatus of claim 16, wherein the means for securing the pedestal to a hitch of a towing vehicle comprises an elongated bar having a proximate end configured for locking engagement with the hitch of a towing vehicle and a mounting plate secured to the elongated bar, said mounting plate engaging a lower end of the pedestal.

27. The apparatus of claim 26, wherein the means for securing the pedestal to a hitch of a towing vehicle further comprises an attachment plate secured between the mounting plate and the elongated bar.
